(19) United States
(12) Patent Application Publication
(10) Pub. No.: US 2006/0238812 A1
(43) Pub. Date: Oct. 26, 2006

(54) Multi-level halftoning apparatus and method thereof

(76) Inventor: Ki-min Kang, Seongnam-si (KR)

Correspondence Address: STANZIONE & KIM, LLP, 919 18TH STREET, N.W., SUITE 440, WASHINGTON, DC, 20006, US

(21) Appl. No.: 11/368,638

(22) Filed: Mar. 7, 2006

(30) Foreign Application Priority Data
Apr. 23, 2005 (KR) 2005-33814

(51) Int. Cl. H04N 1/60

(52) U.S. Cl. 358/3.06; 358/1.9

(57) ABSTRACT

A multi-level halftoning apparatus and method. The multi-level halftoning apparatus includes a two-level quantizer to quantize an input pixel to a white level or an intermediate level between the white level and a black level according to a pixel value of the input pixel, a multi-level generator to convert the pixel quantized to the intermediate level into one of the black level and a plurality of levels between the intermediate level and the black level, and an error filter to distribute a difference value between the pixel value of the input pixel and the level value quantized by the two-level quantizer to adjacent pixels to the input pixel within a predetermined range, to adjust pixel values of the adjacent pixels to be input to the two-level quantizer. Accordingly, since white dots exist in a dark region, it is possible to prevent only black and gray dots from appearing in the dark region and thus prevent an entire image from becoming dark. Also, since a multi-level image is substituted for a two-level image, it is possible to prevent a phenomenon in which gray-levels are not distinguished in the dark region due to an increase of a dot occupancy rate, without increase in the number of dots applied on a print sheet.

### CROSS-REFERENCE TO RELATED APPLICATIONS

This application claims benefit under 35 U.S.C. § 119 from Korean Patent Application No. 2005-33814, filed on Apr. 23, 2005, in the Korean Patent Office, the disclosure of which is incorporated herein in its entirety by reference.

### BACKGROUND OF THE INVENTION

1. Field of the Invention

The present general inventive concept relates to a multi-level halftoning apparatus and method, and more particularly, to a multi-level halftoning apparatus and method which are capable of preventing an entire image from becoming dark and implementing high definition even in a dark region.

2. Description of the Related Art

In general, digital halftoning is used in printers to convert successive color components into a pattern consisting of black dots. In the digital halftoning, input pixels having values between 0 and 255 are converted into two values 0 and 255. Here, 0 represents black, and, if an input pixel has a value of 0, a dot is formed at a location corresponding to the pixel. Also, 255 represents white, and, if an input pixel has a value of 255, white remains at a location corresponding to the pixel without forming any dot.

In the digital halftoning, a screening method and an error diffusion method are typically used. The screening method causes a screen having a matrix corresponding to the size of pixels of an input image to overlap with the input image, and then prints a dot corresponding to the pixel value if each pixel value in the input image is less than the corresponding value in the matrix of the screen.

In the error diffusion method, since input pixel values are quantized to two values 0 and 255, quantization errors are distributed to adjacent pixels considering a fact that the quantized levels have losses, that is, errors with respect to the actual values of the input pixels. In the error diffusion method, a threshold value is set to 128. If a pixel value is greater than 128, it is quantized to 255, thus not forming any dot, and, if a pixel value is less than 128, it is quantized to 0, thus forming a black dot.

FIG. 1 is a block diagram illustrating a multi-level halftoning apparatus based on the conventional error diffusion method. Hereinafter, pattern conversion using the conventional error diffusion method will be described.

Referring to FIG. 1, if an input pixel having a pixel value of 20 is received, a multi-level quantizer 10 quantizes the input pixel to 0 because the pixel value is smaller than 128, so that a dot is formed at a location corresponding to the input pixel. An adder 40 calculates an error which is a difference between the value of the input pixel and the quantization value. The calculated error value is distributed to adjacent pixels at a predetermined rate through an error filter 20, and the distributed error values are input to the adjacent input pixels via an adder 30. Here, the range of the adjacent pixels to which the error value is distributed and the predetermined distribution rate can be arbitrarily set. FIG. 2 illustrates a Floyd-Steinberg error filter 20 in which pixel values are distributed at a predetermined rate to four pixels adjacent to an input pixel.

The pixel values are quantized to two levels 0 and 255. However, in order to more finely represent an image, a three-level error diffusion method of quantizing pixel values to three levels 0, 128, and 255, has been proposed. In the three-level error diffusion method, two threshold values are required for quantization. If it is assumed that the two threshold values are 85 and 170, a pixel having a pixel value less than 85 is quantized to 0 to form a black dot, a pixel having a pixel value greater than 85 and less than 170 is quantized to 128 to form a gray dot, and a pixel having a pixel value greater than 170 is quantized to 255 to form a white dot.

If pixels are quantized using the three-level error diffusion method, a region which is brighter than 128 is represented by gray and white dots, as illustrated in FIG. 3A, and a region which is darker than 128 is represented by gray and black dots, as illustrated in FIG. 3B. Accordingly, as illustrated in FIG. 4, only the black and gray dots appear between the quantization values of 0 and 128, an occupancy rate of the black dots linearly increases the input pixel values approach 0, and the occupancy rate of the gray dots linearly increases the input pixel values approach 128. Also, only the gray and white dots appear between the quantization values of 128 and 255, the occupancy rate of the gray dots linearly increases as the input pixel values approach 128, and the occupancy rate of the white dots linearly increases as the input pixel values approach 255. Accordingly, in a dark region, the brightness of an image is represented by only the black and gray dots. In this case, when the image is actually printed by a printer, it becomes much darker than an original image due to dot overlap, ink spreading, etc.

Generally, if it is assumed that an area on which dots are actually output is a circle passing through four vertices on a digital matrix, as illustrated in FIG. 5, black and white dots appear fifty-fifty. If it is assumed that dots are distributed in a matrix form, an actual occupancy area of the dots is about 78% in 128 levels. If the combination of the black and gray dots of FIG. 4 is converted into an actual dot occupancy rate using the above scheme, as illustrated in a graph of FIG. 6, the dot occupancy rate sharply increases from below a pixel value 128. The dot occupancy rate reaches nearly 100% if the pixel values become smaller than a predetermined value, so that differences between color tones in a dark region are little distinguished.

Meanwhile, in an electrophotographic (EP) printer, charges are applied to an OPC drum using a laser beam and toner is attached to a print sheet by the charges, thereby forming an image. Accordingly, the amount of toner depends on the distribution or amount of the charges applied to the OPC drum. In the EP printer, if an ideal beam profile, such as a square wave, is applied as illustrated in FIG. 7B, the same image (see FIG. 7C) as an original image, as illustrated in FIG. 7A is printed on a print sheet. However, since the beam profile has a Gaussian distribution as illustrated in FIG. 8B, the laser beam affects even a region on which no black dot is formed and toner powders are attached to a region between black dots even though the region is supposed to be a white region, as illustrated in FIG. 9. Accordingly, white regions in an original image, as illustrated in FIG. 8A, have a gray tone as illustrated in FIG. 8C.

This phenomenon is more significant when an image is represented in multi-levels. If the black dots and gray dots are successively positioned, toner powders are attached between the black dots since a few charges exist between the black dots by a Gaussian beam profile, as illustrated in FIG. 10. Furthermore, if the toner powders are attached by the charges for forming the gray dots, the amount of toner attached between the black dots excessively increases, so that the brightness of the gray dots becomes similar to that of the black dots.

As such, according to the conventional error diffusion method, since only the black and gray dots appear between quantization values 0 and 128, and only the gray and white dots appear between quantization values 128 and 255, no white dots exist in a dark region, and accordingly, an image becomes much darker than its original image. Furthermore, since a beam profile for forming the black dots affects adjacent white or gray dots, the adjacent white dots can become gray dots or the adjacent gray dots can become black dots. Accordingly, the entire color tone of an image becomes darker and differences in color tones are little distinguished in a dark region of the image.

Therefore, an error diffusion method which is capable of preventing an entire image from becoming dark and implementing high definition even in a dark region of the image, is desirable.

### SUMMARY OF THE INVENTION

The prevent general inventive concept provides a multi-level halftoning apparatus and method which are capable of preventing an entire image from becoming dark and implementing high definition even in a dark region of the image.

Additional aspects and utilities of the present general inventive concept will be set forth in part in the description which follows and, in part, will be obvious from the description, or may be learned by practice of the general inventive concept.

The foregoing and/or other aspects of the present general inventive concept may be achieved by providing a multi-level halftoning apparatus including a two-level quantizer to quantize an input pixel to a white level or to an intermediate level between the white level and a black level, according to a pixel value of the input pixel, a multi-level generator to convert the pixel quantized to the intermediate level into one of the black level and a plurality of levels between the intermediate level and the black level according to a predetermined condition, and an error filter to distribute a difference value between the pixel value of the input pixel and the level value quantized by the two-level quantizer to adjacent pixels within a predetermined range, to convert pixel values of the adjacent pixels to be input to the two-level quantizer.

The two-level quantizer may quantize the pixel value of the input pixel to one of the white level and the black level and may then quantize the value quantized to the black level to the intermediate level according to an output level.

If the number of pixels having the intermediate level among pixels within a predetermined range exceeds a predetermined number, the multi-level generator converts at least one of the pixels within the predetermined range into the black level or a level between the intermediate level and the black level.

The multi-level generator increases a probability of converting the pixels within the predetermined range into the black level, as the number of the pixels having the intermediate level among the pixels within the predetermined range increases.

The multi-level generator converts the pixel having the intermediate level among the pixels within the predetermined range into the black level or the level between the intermediate level and the black level.

The multi-level generator converts a final pixel of the pixels having the intermediate level within the predetermined range along a scan direction, into the black level or the level between the intermediate level and the black level.

The multi-level halftoning apparatus may include a level conversion table to store information regarding the number and arrangement of pixels to be converted into the black level or the level between the intermediate level and the black level, among the pixels having the intermediate level, according to any one of the number and arrangement of the pixels having the intermediate level within the predetermined range.

The multi-level generator may convert the quantized pixel having the intermediate level into the black level or the level between the intermediate level and the black level, based on the information stored in the level conversion table.

The foregoing and/or other aspects of the present general inventive concept may also be achieved by providing a multi-level halftoning apparatus, including a 2-level quantizer to quantize a pixel value of each of sequentially input pixels into one of a white value and a black value and to quantize each black value into a predetermined intermediate value between the white value and the black value, and a multi-level converter to group the sequentially input pixels having the quantized pixel values into groups of a predetermined size and to selectively convert the pixel value at least one of the pixels in each group having the predetermined the intermediate value from the predetermined intermediate value to one of the black value and a value between the intermediate value and the value based on a number of pixels in each group having the intermediate value.

The foregoing and/or other aspects of the present general inventive concept may also be achieved by providing a multi-level halftoning method including quantizing an input pixel to a white level or an intermediate level between the white level and a black level according to a pixel value of the input pixel, distributing a difference value between the quantized level value and the pixel value of the input pixel to adjacent pixels to the input pixel within a predetermined range, and converting the pixel quantized to the intermediate level into one of the black level and a plurality of levels between the intermediate level and the black level.

The foregoing and/or other aspects of the present invention, there is provided general inventive concept may also be achieved by providing a multi-level halftoning method including quantizing pixel values of each of sequentially input pixels into a white value and a black value, quantizing each of the black values of the sequentially input pixels into an intermediate value between the white and black values, grouping the sequentially input pixels into a plurality of groups having a predetermined size, and selectively converting the pixel value of at least one of the pixels having an intermediate value in each group from a the intermediate value to one of the black value and a value between the intermediate value and the black value based on the number of pixels having the intermediate value in each group.

The foregoing and/or other aspects of the present invention, there is provided general inventive concept may also be achieved by providing a multi-level halftoning method including quantizing input pixels into white dots and gray dots, counting a number of gray dots in a predetermined range of the input pixels, and converting one of the gray dots in the predetermined range into one of a black dot and a plurality dark gray dots when the number of gray dots in the predetermined range is greater than a predetermined number.

The foregoing and/or other aspects of the present invention, there is provided general inventive concept may also be achieved by providing a computer readable recording medium having executable codes to perform a multi-level halftoning method including quantizing an input pixel to a white level or an intermediate level between the white level and a black level according to a pixel value of the input pixel, distributing a difference value between the quantized level value and the pixel value of the input pixel to adjacent pixels to the input pixel within a predetermined range, and converting the pixel quantized to the intermediate level into one of the black level and a plurality of levels between the intermediate level and the black level.

The foregoing and/or other aspects of the present invention, there is provided general inventive concept may also be achieved by providing a computer readable recording medium having executable codes to perform a multi-level halftoning method including quantizing pixel values of each of sequentially input pixels into a white value and a black value, quantizing each of the black values of the sequentially input pixels into an intermediate value between the white and black values, grouping the sequentially input pixels into a plurality of groups having a predetermined size, and selectively converting the pixel value of at least one of the pixels having an intermediate value in each group from a the intermediate value to one of the black value and a value between the intermediate value and the black value based on the number of pixels having the intermediate value in each group.

The foregoing and/or other aspects of the present invention, there is provided general inventive concept may also be achieved by providing a computer readable recording medium having executable codes to perform a multi-level halftoning method including quantizing input pixels into white dots and gray dots, counting a number of gray dots in a predetermined range of the input pixels, and converting one of the gray dots in the predetermined range into one of a black dot and a plurality dark gray dots when the number of gray dots in the predetermined range is greater than a predetermined number.

### BRIEF DESCRIPTION OF THE DRAWINGS

The present general inventive concept will be described in detail with reference to the following drawings in which like reference numerals refer to like elements, and wherein:

FIG. 1 is a block diagram illustrating a multi-level halftoning apparatus based on a conventional error diffusion method;

FIG. 2 is a view illustrating a Floyd-Steinberg error filter;

FIG. 3A is an image illustrating an error diffused result when pixel values are greater than 128 in a conventional three-level halftoning method, and FIG. 3B is an image illustrating an error diffused result when pixel values are smaller than 128 in the conventional three-level halftoning method;

FIG. 4 is a graph illustrating a beam profile used for the conventional three-level halftoning method;

FIG. 5 is a graph illustrating an actual occupancy rate between gray dots and black dots in the conventional three-level halftoning method;

FIG. 6 is a graph illustrating a total dot occupancy rate in the conventional three-level halftoning method;

FIGS. 7A, 7B and 7C are views illustrating outputs with respect to an input image when an ideal beam profile is applied;

FIGS. 8A, 8B and 8C are views illustrating outputs with respect to an input image when an actual beam profile is applied;

FIG. 9 is an image illustrating a state in which toner is attached to a print sheet when a white dot exists between a pair of black dots, according to a conventional technique;

FIG. 10 is an image illustrating a result obtained by applying a conventional three-level error diffusion method to the view of FIG. 9;

FIG. 11 is a block diagram illustrating a multi-level halftoning apparatus according to an embodiment of the present general inventive concept;

FIG. 12 is a graph illustrating an actual occupancy rate of gray dots when the multi-level halftoning apparatus of in FIG. 11 is used;

FIG. 13 is a graph illustrating a distribution relationship of black dots with respect to input pixel values;

FIG. 14 is a view illustrating a method in which conversion is performed by a multi-level generator when an output level is a four-level; and

FIG. 15 is a graph illustrating a dot occupancy rate when the multi-level halftoning apparatus of FIG. 11 is used.

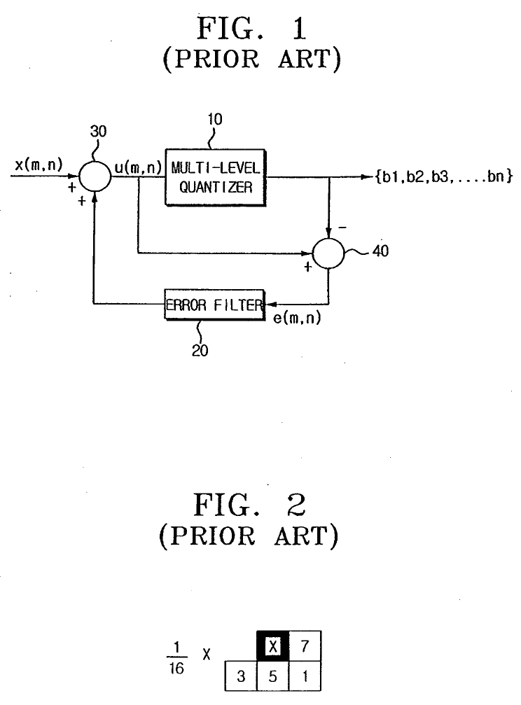

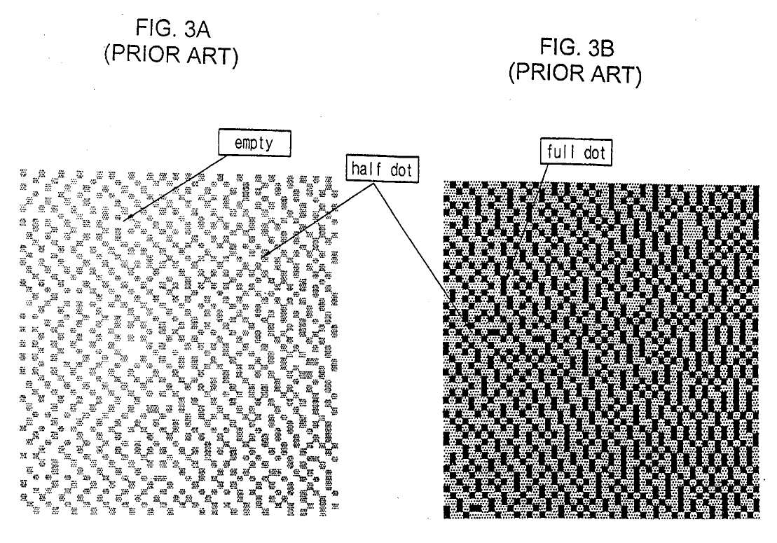

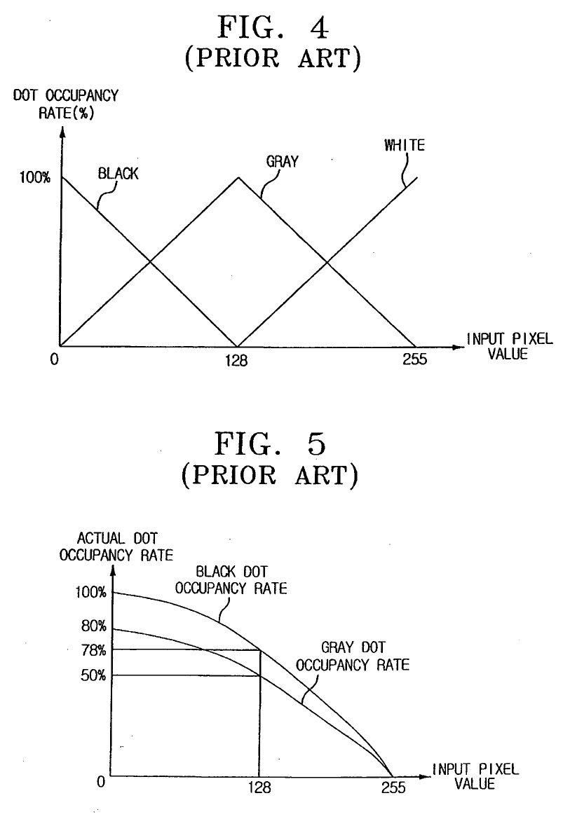

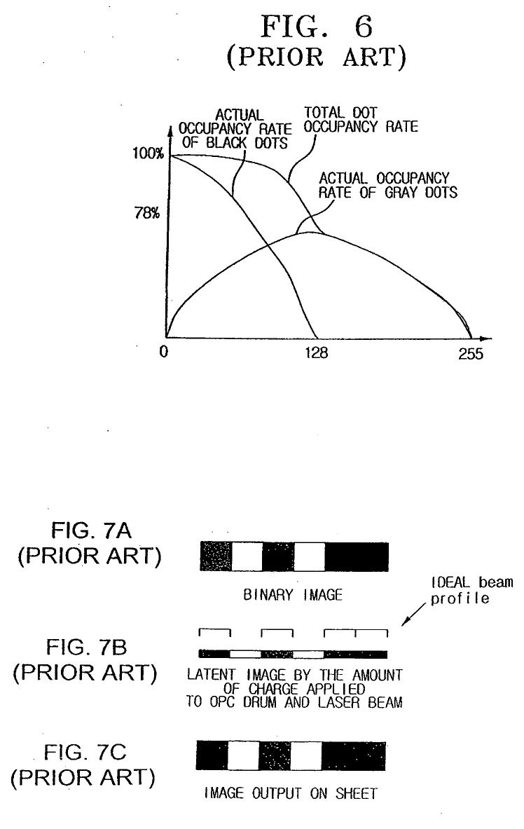

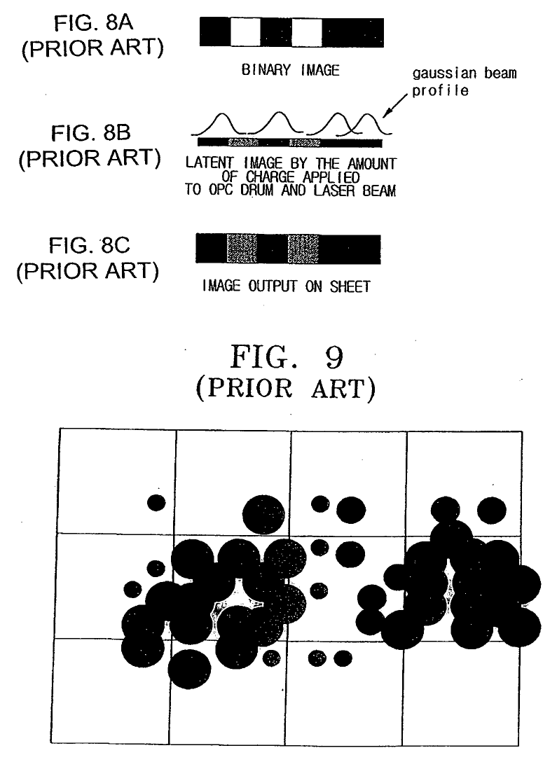

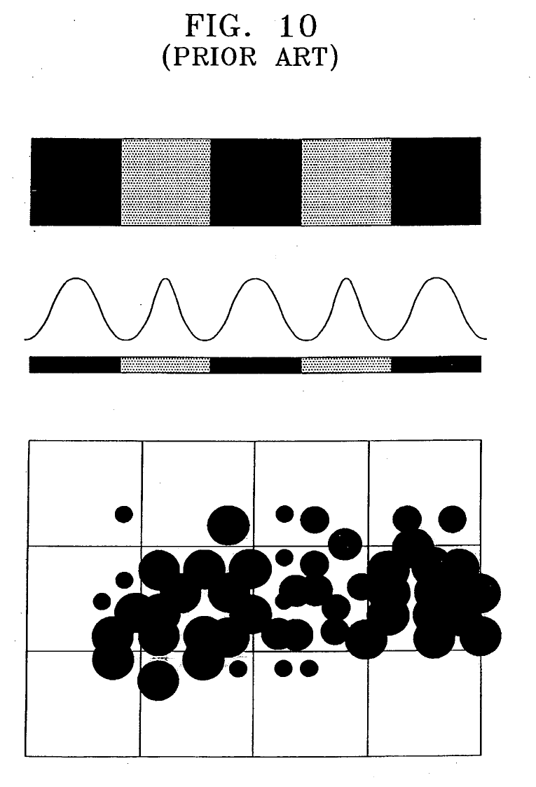

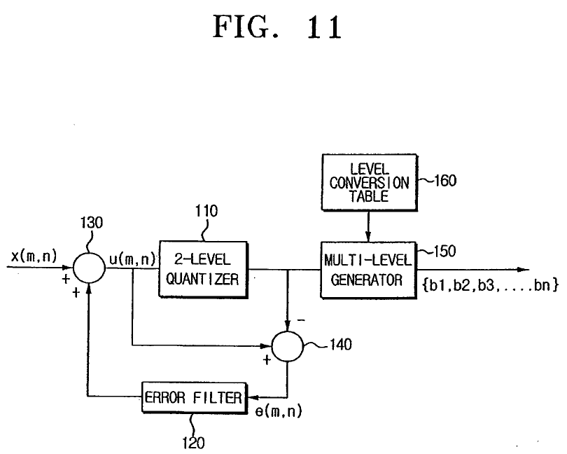

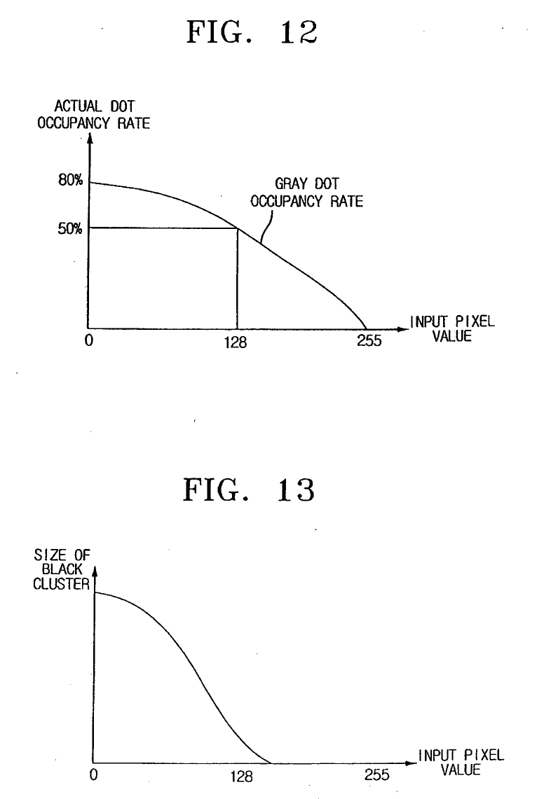

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

FIG. 11 is a block diagram illustrating a multi-level halftoning apparatus according to an embodiment of the present general inventive concept. Referring to FIG. 11, the multi-level halftoning apparatus includes a two-level quantizer 110, an error filter 120, a level conversion table 160, a multi-level generator 150, and first and second adders 130 and 140.

The two-level quantizer 110 receives an input pixel x(m, n) having a pixel value between 0 and 255 and quantizes the pixel value to 255 or 0, in case of a multi-level output. Then, error calculation and error propagation to adjacent pixels are performed in the same manner as in a two-level output, in the multi-level output. Then, the two-level quantizer 110 substitutes different values for the pixel values quantized to 0 according to an output level. For example, in a three-level output, the two-level quantizer 110 converts each pixel value quantized to 0 into a value corresponding to an intermediate level, such as 128. That is, grey dots (pixels having the intermediate pixel value) are substituted for black dots (pixels having the pixel value of 0). In a four-level output, the two-level quantizer 110 converts each pixel value quantized to 0 into a ¾ level, that is, a level of 170. Through this operation, the two-level quantizer 110 outputs an image that is represented by only white and gray dots.

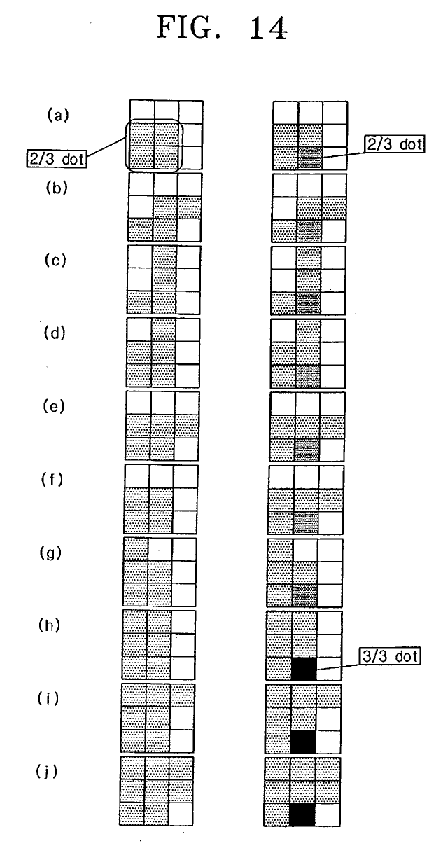

Accordingly, the image output from the two-level quantizer 110 is represented by only white and gray dots, as illustrated in a left portion of FIG. 14. Accordingly, when the pixel values of the input pixels are quantized to two levels to thus substitute the gray dots for the black dots, an actual occupancy rate of the gray dots reaches 80% when the pixels values of the input pixels are 0, and reaches 50% when the pixel values of the input pixels are 128, as illustrated in FIG. 12. The pixel values quantized to two levels by the two-level quantizer 110 are divided into multiple levels by the multi-level generator 150.

The multi-level generator 150 converts the pixels quantized to the intermediate level between the two levels quantized by the two-level quantizer 110, into a plurality of levels between the intermediate level and a black level or into the black level. If the two-level quantizer 110 performs the quantization based on the three-level output, that is, if the two-level quantizer 110 quantizes an input pixel to 255 or 128, the multi-level generator 150 converts the pixel values of some of pixels quantized to 128 to 0 and forms black dots corresponding to the converted pixels on the image. If the two-level quantizer 110 performs the quantization based on the four-level output, that is, if the two-level quantizer 110 quantizes an input pixel to 255 or 170, the multi-level generator 150 converts the pixel values of some of pixels quantized to 170 into 85 or 0, thereby dividing the pixels into a plurality of levels.

The size of a cluster having only black dots in a two-level converted image can become greater as an input image becomes darker, and can become smaller as the input image becomes brighter, as illustrated in FIG. 12. Accordingly, probabilistically, if a pixel cluster having a predetermined size is filled with only black dots, the size of the pixel cluster increases as the pixel values decrease from 128 to 0. FIG. 13 illustrates a probability that all pixels in a 3×3 region will be black dots. As illustrated in FIG. 13, since all of the pixels are black dots when the corresponding pixel values are 0, the corresponding 3×3 region is always filled with black dots. By using the probability, it is possible to convert pixels quantized to two levels into three or more levels.

For example, when the two-level image quantized to two levels, having only white and gray dots, is converted into the three-level image, if a major part of a 3×3 region is filled with gray dots, as illustrates in the left portion of FIG. 14(i), an arbitrary target pixel within the 3×3 region is converted into a black dot, as illustrated in a right portion of FIG. 14(i). The target pixel can be randomly set to one of the gray dots in a predetermined region, for example, in the 3×3 region, or can be set to a final gray dot among the gray dots in the 3×3 region along a scan direction from a left side to a right side and/or a top side to a bottom side. The target pixel can be set in various ways. Accordingly, when the target pixel is substituted by the black dot, black dots are substituted for grey dots in dark regions of the image according to the probability characteristic illustrated in FIG. 13.

The multi-level generator 150 converts the pixels quantized to gray dots by the two-level quantizer 110 into dark gray dots or black dots, when an image is implemented in four or more levels. The level conversion table 160 stores information regarding locations of the target pixels in an arbitrary m×n dot cluster, whose gray dots will be converted into the dark gray dots or the black dots, etc.

FIGS. 14(a) through 14(j) illustrate a case where a gray dot is converted into a dark gray dot or a black dot in a 3×3 region. As illustrated in FIG. 14(a), if four gray dots are arranged in a 2×2 format, the final gray dot along the scan direction can be converted into the dark gray dot. Similarly, as illustrated in FIGS. 14(b) and 14(c), the final gray dot of four gray dots along the scan direction is converted into the dark gray dot. As illustrated FIGS. 14(d) through 14(g), when there are five gray dots in the 3×3 region, the final gray dot in the scan direction is converted into the dark gray dot. As illustrated in FIGS. 14(h) through 14(j), when there are six or more gray dots in the 3×3 region, the final gray dot in the scan direction is converted into the black dot. Accordingly, the embodiments illustrated in FIGS. 14(a) through 14(j) illustrate a case in which the 3×3 region is set as a reference range and an image output of pixels is set to a four levels. Accordingly, the level conversion table 160 stores the reference range for the conversion from the 2 levels quantized by the 2-level quantizer 110 to the four levels, and information regarding setting target pixels to be converted into the dark gray dots or the black dots, etc., according to the number and arrangement of the gray dots within the reference range. The multi-level generator 150 performs the dot conversion based on the information stored in the level conversion table 160 when in order to represent the image in a three or more levels.

The error filter 120 compensates for an error value e(m, n) obtained from a difference between a level value quantized by the two-level quantizer 110 and an original pixel value, and distributes the error value e(m, n) to a plurality of adjacent pixels to the quantized pixel value, wherein the adjacent pixels are pixels positioned after the quantized pixel value in the scanning direction of the image. Various error distribution methods can be used according to a range of the pixels to which the error value is distributed, a rate at which the error value is distributed, etc. For example, a Floyd-Steinberg error filter can be used as the error filter 120, but the present general inventive concept is not limited thereto.

The first adder 130 adds the error value e(m, n) distributed by the error filter 120 with the input pixel value of each adjacent pixel and outputs a compensated pixel value u(m, n). The 2-level quantizer 110 performs quantizing the adjacent pixels based on the compensated pixel values of the adjacent pixels.

The second adder 140 adds the compensated pixel value u(m, n) of each adjacent pixel with a difference between the value quantized by the two-level quantizer 110 and the compensated pixel value u(m, n), and obtains a new error value e(m, n) for each adjacent pixel.

Hereinafter, a process in which the multi-level halftoning apparatus having the structure described above performs multi-level halftoning using an error diffusion method, will be described.

When a pixel is received, the two-level quantizer 110 quantizes the pixel value of the received pixel to 255 or 0 and then quantizes the value quantized to 0 to an intermediate threshold value, according to a predetermined output level. If the output level is a three-level, the two-level quantizer 110 can substitute the intermediate value of 128 for the value quantized to 0. If the output level is a four-level, the two-level quantizer 110 can substitute the intermediate value of 170 for the value quantized to 0 by 170.

After the quantization is complete, a difference between the pixel value obtained by the quantization and the original pixel value of the pixel is obtained as an error value by the second adder 140 and fed back to the error filter 120. The error filter 120 divides the error value at a predetermined rate and the divided error values are fed back and combined with pixel values of input pixels adjacent pixels to the quantized pixel within a predetermined range.

The quantized pixel value is provided to the multi-level generator 150. The multi-level generator 150 converts the pixel quantized to the intermediate threshold value by the two-level quantizer 110 into one of a plurality of levels according to the output level. If the output level is the three-level, some of the pixels quantized to 128 (that is, pixels formed as gray dots) are converted into black dots according to a predetermined probability. The multi-level generator 150 divides pixels into groups having a predetermine range and converts a specific target pixel in each group into the black dot, wherein the target pixel is one of pixels formed as the gray dots. A method of converting a target pixel into the black dot is determined according to the number and arrangement of the gray dots belonging to each group having the predetermined range. As the number of gray dots within the predetermined range increases and the arrangement of gray dots is dense, the probability that the gray dots will be converted into black dots increases.

If the output level is the four-or-more-level, some of the pixels quantized to 170 are converted into dark gray dots or black dots. At this time, the multi-level generator 150 converts target pixels into a plurality of levels, such as the dark gray dots or the black dots, etc. on the basis of information stored in the level conversion table 160.

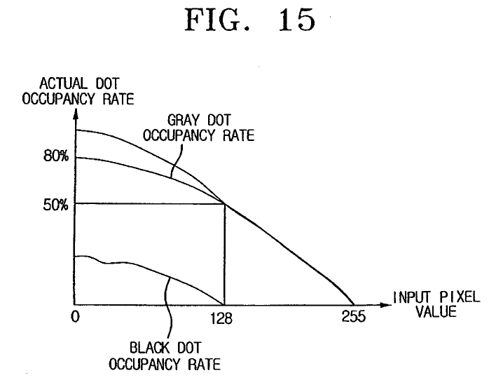

Through use of the multi-level halftoning apparatus, since the black dots are substituted for the gray dots, the number of gray dots decreases by the number of newly generated black dots. Accordingly, as illustrated in FIG. 15, a total occupancy rate of dots nearly linearly varies when the pixel values decreases from 255 to 0. In other words, it is possible to prevent the total number of dots from increasing when gray and black dots are simultaneously formed. Accordingly, since white exists in dark regions of the image, it is possible to prevent only gray and black dots from appearing in the dark regions as in a conventional technique and thus prevent an entire image from becoming dark. Also, since a multi-level image is substituted for a two-level image, the number of dots applied on a print sheet does not increase. Accordingly, it is possible to minimize a phenomenon in which gray-levels are not distinguished in a dark region due to increase in a dot occupancy rate.

It is possible for the present general inventive concept to be realized on a computer-readable recording medium as a computer-readable code. Computer-readable recording mediums include many types of recording devices that store computer system-readable data. ROMs, RAMs, CD-ROMs, magnetic tapes, floppy discs, optical data storage, etc. are used as computer-readable recording mediums. Computer-readable recording mediums can also be realized in the form of carrier waves (e.g., transmission via Internet).

As described above, according to the present general inventive concept, since white exists in a dark region, it is possible to prevent only gray and black dots from appearing in a dark region and thus prevent an entire image from becoming dark. Also, since a multi-level image is substituted for a two-level image, it is possible to prevent a phenomenon in which gray-levels are not distinguished in a dark region due to the increase of a dot occupancy rate, without increase in the number of dots applied on a print sheet.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. The multi-level halftoning apparatus comprising:
a two-level quantizer to quantize an arbitrary input pixel to one of a white level and an intermediate level between the white level and a black level, according to a pixel value of the input pixel;
a multi-level generator to convert the pixel quantized to the intermediate level into one of the black level and a plurality of levels between the black level and the intermediate level according to a predetermined condition; and
an error filter to distribute a difference value between the pixel value of the input pixel and the quantized value of the input pixel quantized by the two-level quantizer to adjacent pixels of the input pixel within a predetermined range, to adjust pixel values of the adjacent pixels to be input to the two-level quantizer.

2. The multi-level halftoning apparatus of claim 1, wherein the two-level quantizer quantizes the pixel value of the input pixel to one of the white level and the black level and then quantizes the value quantized to the black level to the intermediate level according to an output level.

3. The multi-level halftoning apparatus of claim 2, wherein the intermediate level comprises a value closest to the white level, among a plurality of values into which pixel values between the white level and the black level are equally divided according to the output level.

4. The multi-level halftoning apparatus of claim 1, wherein, if a number of pixels having the intermediate level among pixels within a predetermined range exceeds a predetermined number, the multi-level generator converts at least one of the pixels within the predetermined range into the black level or a level between the intermediate level and the black level.

5. The multi-level halftoning apparatus of claim 4, wherein the multi-level generator increases a probability of converting the pixels within the predetermined range into the black level, as the number of the pixels having the intermediate level among the pixels within the predetermined range increases.

6. The multi-level halftoning apparatus of claim 4, wherein the multi-level generator converts a pixel having the intermediate level among the pixels within the predetermined range into the black level or the level between the intermediate level and the black level.

7. The multi-level halftoning apparatus of claim 6, wherein the multi-level generator converts a final pixel of the pixels having the intermediate level within the predetermined range along a scan direction, into the black level or the level between the intermediate level and the black level.

8. The multi-level halftoning apparatus of claim 1, further comprising:
a level conversion table to store information regarding the number and arrangement of pixels to be converted into the black level or the level between the intermediate level and the black level, among the pixels having the intermediate level, according to any one of the number and arrangement of the pixels having the intermediate level within the predetermined range.

9. The multi-level halftoning apparatus of claim 8, wherein the multi-level generator converts the quantized pixel having the intermediate level into the black level or the level between the intermediate level and the black level, based on the information stored in the level conversion table.

10. A multi-level halftoning apparatus, comprising:
a 2-level quantizer to quantize a pixel value of each of sequentially input pixels into one of a white value and a black value and to quantize each black value into a predetermined intermediate value between the white value and the black value; and
a multi-level converter to group the sequentially input pixels having the quantized pixel values into groups of a predetermined size and to selectively convert the pixel value at least one of the pixels in each group having the predetermined the intermediate value from the predetermined intermediate value to one of the black value and a value between the intermediate value and the value based on a number of pixels in each group having the intermediate value.

11. The multi-level halftoning apparatus of claim 10, wherein the predetermined intermediate value comprises a gray value.

12. The multi-level halftoning apparatus of claim 11, wherein when the number of pixels having the intermediate value in one of the groups is greater than or equal to a first reference number, the multi-level converter converts the pixel value of one pixel of the group into the black value, and when the number of pixels having the intermediate value in one of the groups is les than the first reference number and greater than a second reference number, the multi-level converter converts the pixel value of one pixel of the group into a dark gray value.

13. The multi-level halftoning apparatus of claim 10, wherein the multi-level converter converts a last input one of the pixels having the intermediate value to the one of the black value and the value between the intermediate value and the black value in each group having a predetermined number or more pixels having the intermediate value.

14. The multi-level halftoning apparatus of claim 10, further comprising:
an error unit to calculate an error value between the quantized value and the input pixel value of each sequentially input pixel and to distribute the calculated error value to adjacent pixels of the sequentially input pixels to adjust the input pixel values of the adjacent pixels.

15. A multi-level halftoning method comprising:
quantizing an input pixel to a white level or an intermediate level between the white level and a black level according to a pixel value of the input pixel;
distributing a difference value between the quantized level value and the pixel value of the input pixel to adjacent pixels to the input pixel within a predetermined range; and
converting the pixel quantized to the intermediate level into one of the black level and a plurality of levels between the intermediate level and the black level.

16. The multi-level halftoning method of claim 15, wherein the quantizing of the input pixel comprises:
quantizing the pixel value of the input pixel to the white level or the black level; and
quantizing the pixel value quantized to the black level to the intermediate level according to an output level.

17. The multi-level halftoning method of claim 15, wherein, the converting of the pixel quantized to the intermediate level into one of the black level and the plurality of levels between the intermediate level and the black level comprises:
if the number of pixels having the intermediate level among pixels within a predetermined range exceeds a predetermined number, converting at least one of the pixels within the predetermined range into the black level or one of the plurality of levels between the intermediate level and the black level.

18. The multi-level halftoning method of claim 17, wherein in the converting of the pixel quantized to the intermediate level into one of the black level and the plurality of levels between the intermediate level and the black level further comprises:
increasing a probability of converting the at least one of the pixels within the predetermined range into the black level as the number of pixels having the intermediate level within the predetermined range increases.

19. The multi-level halftoning method of claim 18, wherein the converting of at least one of the pixels within the predetermined range into the black level or one of the plurality of levels between the intermediate level and the black level comprises:
converting one of the pixels having the intermediate level among the pixels within the predetermine range into the black level or the one of the plurality of levels between the intermediate level and the black level.

20. The multi-level halftoning method of claim 19, wherein the converting of one of the pixels having the intermediate level among the pixels within the predetermine range into the black level or the one of the plurality of levels comprises:
converting a final pixel of the pixels having the intermediate level within the predetermined range along a scan direction into the black level or the one of the plurality of levels between the intermediate level and the black level.

21. A multi-level halftoning method, comprising:
quantizing pixel values of each of sequentially input pixels into a white value and a black value;
quantizing each of the black values of the sequentially input pixels into an intermediate value between the white and black values;
grouping the sequentially input pixels into a plurality of groups having a predetermined size; and
selectively converting the pixel value of at least one of the pixels having an intermediate value in each group from a the intermediate value to one of the black value and a value between the intermediate value and the black value based on the number of pixels having the intermediate value in each group.

22. A multi-level halftoning method, comprising:
quantizing input pixels into white dots and gray dots;
counting a number of gray dots in a predetermined range of the input pixels; and
converting one of the gray dots in the predetermined range into one of a black dot and a plurality dark gray dots when the number of gray dots in the predetermined range is greater than a predetermined number.

23. A computer readable recording medium having executable codes to perform a multi-level halftoning method, the method comprising:
quantizing an input pixel to a white level or an intermediate level between the white level and a black level according to a pixel value of the input pixel;
distributing a difference value between the quantized level value and the pixel value of the input pixel to adjacent pixels to the input pixel within a predetermined range; and
converting the pixel quantized to the intermediate level into one of the black level and a plurality of levels between the intermediate level and the black level.

24. A computer readable recording medium having executable codes to perform a multi-level halftoning method, the method comprising:
quantizing pixel values of each of sequentially input pixels into a white value and a black value;
quantizing each of the black values of the sequentially input pixels into an intermediate value between the white and black values;
grouping the sequentially input pixels into a plurality of groups having a predetermined size; and
selectively converting the pixel value of at least one of the pixels having an intermediate value in each group from a the intermediate value to one of the black value and a value between the intermediate value and the black value based on the number of pixels having the intermediate value in each group.

25. A computer readable recording medium having executable codes to perform a multi-level halftoning method, the method comprising:
quantizing input pixels into white dots and gray dots;
counting a number of gray dots in a predetermined range of the input pixels; and
converting one of the gray dots in the predetermined range into one of a black dot and a plurality dark gray dots when the number of gray dots in the predetermined range is greater than a predetermined number.
